(19) United States
(12) Patent Application Publication
(10) Pub. No.: US 2014/0283446 A1
(43) Pub. Date: Sep. 25, 2014

(54) WATER SUPPLY DEVICE FOR PLANTING

(71) Applicant: MAO-CHIANG KUO, TAINAN CITY (TW)

(72) Inventor: MAO-CHIANG KUO, TAINAN CITY (TW)

(21) Appl. No.: 14/186,099

(22) Filed: Feb. 21, 2014

(30) Foreign Application Priority Data
Mar. 22, 2013 (TW) 102205334

(51) Int. Cl. A01G 29/00

(52) U.S. Cl. CPC A01G 29/00
USPC 47/48.5

(57) ABSTRACT

A water supply device put on the soil or buried in the soil in which the plants are planted. The water supply device includes a first part, a second part and a pipe. The first part is an annular part with a notch. The first part has a water storage space for storing water therein. The second part is located within the notch of the first part and has a room for storing fertilizer therein. The pipe is arranged along the first part and connected between the water storage space and the room. The pipe has a plurality of apertures distributed over the wall thereof. By using principles of differential-pressure and siphon, the water and fertilizer automatically move and are supplied to the plants so as to save time, expenses and efforts.

### BACKGROUND OF THE INVENTION

1. Fields of the invention

The present invention relates to a water supply device, and more particularly, to a water supply device which uses principles of differential-pressure and siphon to supply the water and the fertilizer to the plants.

2. Descriptions of Related Art

The modern cities are filled with high rises, vehicles, and high density of population so that everyone only shares a very limited space. Air pollution makes the urban life worse than ever. Therefore, people who live in the cities are eager to green their surrounding by planting green plants in the limited space. However, it takes a lot of time to take care of the plants and most of the people do not have sufficient time to water and feed the plants routinely due to their style of life, so that the plants get sick or die within short period of time. To solve the above-mentioned problem, Taiwan Patent No. 1397628, entitled “Automatic Water Supply Device for Plant Pot,” discloses a water storage unit, a transmission unit connected with the water storage unit for delivering water, and at least one suction unit connected with the transmission unit and the planting medium. The suction unit and the transmission unit are isolated from each other. When the water storage unit and the transmission unit are filled with water, the two respective pressures of the water storage unit and the transmission unit are equal to each other. Therefore, when the planting medium absorbs water from the suction unit, the transmission unit has a negative pressure so that the water in the water storage unit flows toward the transmission unit and the suction unit, thus raising the water level and providing the water transmission function. Taiwan Utility Model No. M420980, entitled “Auto Watering Device,” discloses a water storage unit for storing water therein, a fluid level control unit disposed in the water storage unit for controlling the water level in the water storage unit, a dispensing unit connected to the fluid level control unit to dispense water to other water storage units, a water-flow control unit connected to the water storage unit so as to control the amount of the water flow, and a pipe connected to the water-flow control unit to deliver the water to the plant pot. Therefore, the auto watering device automatically supplies water to the plants by means of the pipes connected with the water storage unit.

Taiwan Utility Model No. M385924 discloses a method to maintain the humidity in the plant pot so as to prevent the water in the pot from being vaporized and to reduce the times of watering. The method utilizes a sealable casing with a cup tightly coupled to the top of the casing, thus forming a water storage room within the casing. The water is supplied to the cup to water the plants, and the extra water flows into the water storage room. When the humidity in the cup reduces, a suction member sucks water from the water storage room and sends the water into the cup. By the sealable casing and the internal circulation of water supply, the humidity in the cup can be maintained for a longer period of time.

Taiwan Patent No. 1329495, entitled “Method and Device for Supplying Water and Fertilizer,” provides the soil around the plant root with a plurality of vertical holes in which the fertilizer sticks are inserted. A water supplying device then provides a small amount of water to the fertilizer sticks so that the water enters into the bottom layer of the soil via the fertilizer sticks and is absorbed by roots of the plant. Taiwan Patent No. 386343, entitled “Plant Pot,” discloses a pot, a cover and two containers, wherein the pot has a plurality of passages crisscross arranged on the bottom thereof. The altitude passages communicate with a water tank which is disposed on one side of the plant pot. The water tank has fertilizer packs accommodated therein and the cover is mounted to and seals the top of the water tank. The two containers are screwed with the top of the cover so as to guide the water stored in the containers into the passages, such that the plants in the plant pot can absorb the water and fertilizer continuously.

The shortcomings of the conventional watering devices are that the water storage unit or containers occupy space and the pipes need to be connected and organized. The pipes may be damaged by external forces. The water only supplied to partial surface of the soil so that the soil cannot have even amount of water to be absorbed, which may cause that the soil has one area with too much water, and another area is still dry so that the growth of the plant may be adversely affected. Besides, since the fertilizer accompanies with the water to be supplied to the soil, the plant may absorb too much fertilizer and thus cannot grow well. Moreover, some of the above-mentioned water supply devices do not have the function of supplying the fertilizer together with the water.

The present invention intends to provide a water supply device which is used to water the plant within a pot or a small area, and to provide the plant with water and fertilizer properly within a long period of time, so as to improve the shortcomings mentioned above.

### SUMMARY OF THE INVENTION

The present invention relates to a water supply device adapted to be put on or buried in the soil for planting. The water supply device comprises an annular first part with a notch and has a water storage space for storing water therein. The first part has an inlet and an outlet, which are in communication with the water storage space. A second part is located within the notch of the first part and has a room for accommodating fertilizer therein. The second part has an opening and at least two first orifices. The opening and the at least two first orifices are in communication with the room. A pipe is installed along the first part and connected with the outlet of the first part and the at least two first orifices of the second part so as to form a first flow path. The pipe has a plurality of apertures distributed over the wall thereof.

Preferably, the room of the second part has a separation member located therein, and the separation member separates the room into a top room and a bottom room. The top room is configured to accommodate the fertilizer therein. The top room communicates with the bottom room, and the at least two first orifices are located at the bottom room. Preferably, the room of the second part has a separation member located therein. The separation member separates the room into a top room and a bottom room. The top room is configured to accommodate the fertilizer therein. The top room does not communicate with the bottom room, and the at least two first orifices are located at the top room.

Preferably, the bottom room has at least two second orifices, and the at least two second orifices are in connection with the pipe so as to form a second flow path.

Preferably, a valve is coupled to the outlet of the first part.

Preferably, a water level meter is coupled to the first part and communicates with the water storage space to measure a water level of the water storage space.

Preferably, the pipe is coupled with the first part and located below the first part.

Alternatively, the present invention provides a water supply device adapted to be placed at periphery of a plant, and the water supply device comprises a first part for receiving water therein, a second part for receiving fertilizer therein, and a pipe connected between the first and second parts. The pipe has a plurality of apertures distributed over the wall thereof.

The primary object of the present invention is to provide a water supply device which supplies water and fertilizer in one time so as to reduce the burden of taking care of the plants.

The water storage room is simply placed on the planting area when in use. This arrangement does not occupy much space, and the complex arrangement of pipe is not needed either, thus convenient to use and more reliable.

The water supply device of the present invention prevents the plant from absorbing too much fertilizer and provides a good growth condition.

The water supply device of the present invention supplies water to the plant evenly so as to maintain a good growth condition to the plant.

The water supply device of the present invention has a simple structure which saves expenses, time, efforts and energy, and makes the plant be healthy with simple operation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of a water supply device in accordance with a first embodiment of the present invention; FIG. 2 shows a second part of the water supply device in accordance with the first embodiment of the present invention;

FIG. 3 shows a second part of a water supply device in accordance with a second embodiment of the present invention;

FIG. 4 shows an application of the water supply device of the present invention, wherein the water supply device is placed in a plant pot;

FIGS. 5 and 6 show the operation steps of the present invention; and

FIG. 7 shows another application of the water supply device of the present invention.

### DETAILED DESCRIPTION OF THE PREFERRED EMBODIMENT

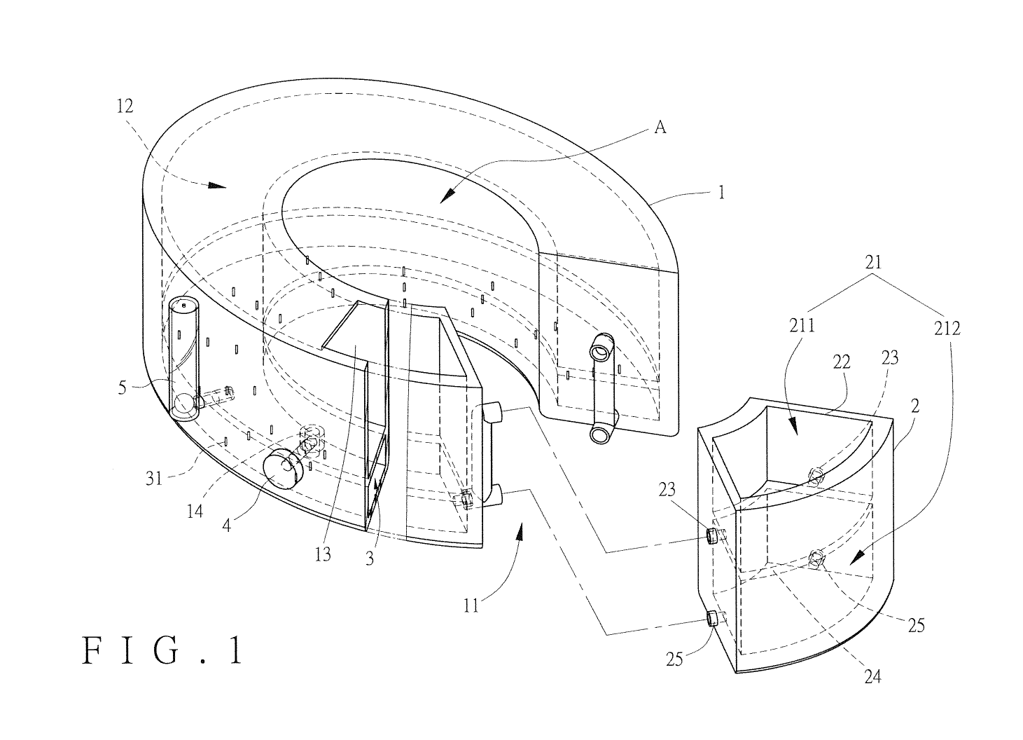

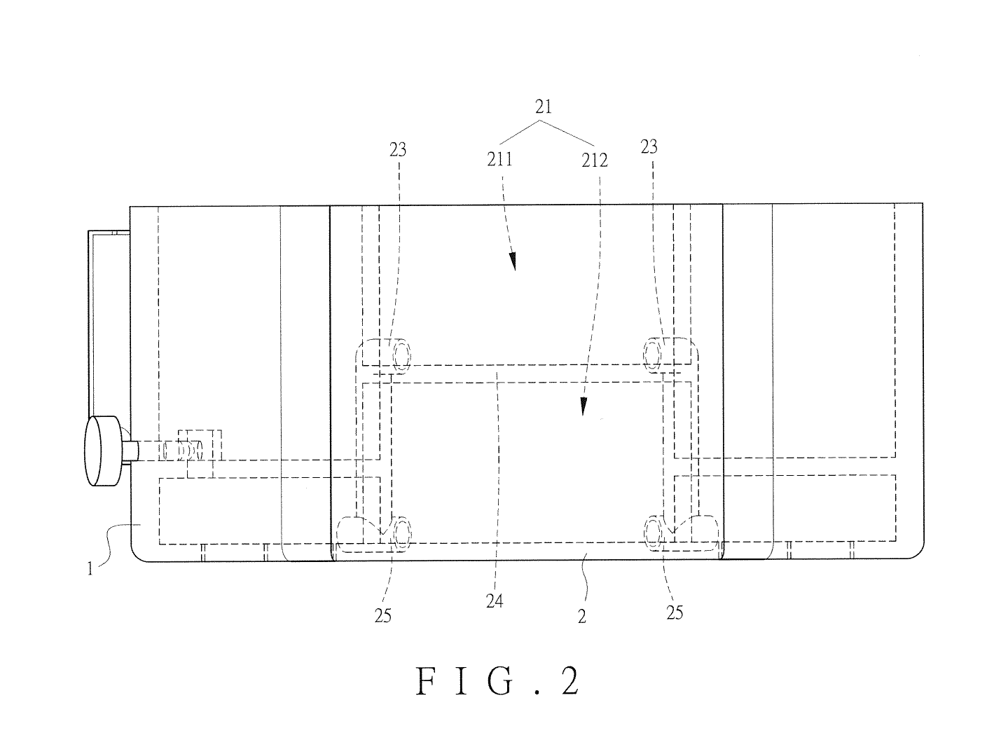

FIG. 1 shows a preferred embodiment of the present invention, wherein a water supply device applied to be placed on or buried in the soil in which a plant grow can store water and fertilizer therein and can automatically supply the water and fertilizer stored therein to the plant by using principles of differential-pressure and siphon, so as to save water, time, expenses and efforts, and to be environmentally friendly.

In one application, the water supply device is placed at the periphery of the plant. The water supply device comprises a first part 1 for storing the water therein and a second part 2 for accommodating the fertilizer therein. The first part 1 and the second part 2 communicate with each other via a pipe 3 which is connected between the first part 1 and the second part 2. The pipe 3 has a plurality of apertures 31 distributed over the wall thereof such that the water in the first part 1 and the second part 2 can passes through the plurality of apertures 31 to evenly supply the water and fertilizer to the soil for planting.

The first part 1, adapted for storage of the water, is an annular part with a notch 11 formed thereon and has a water storage space 12 defined therein. The first part 1 also has an inlet 13 and an outlet 14 which are in communication with the water storage space 12. In detail, the inlet 13 is used to introduce water into the water storage space 12, and the outlet 14 is used to allow the water stored in the water storage space 12 to be supplied to the plant. It is noted that the first part 1 can be any shape, such as circular, oval, rectangular, triangular or polygonal shape, as long as there is a central hole “A” through which the plant can grow.

The second part 2, adapted for accommodation of the fertilizer, is located within the notch 11 of the first part 1 and has a room 21 for accommodating the fertilizer therein. The second part 2 further has an opening 22 and at least two first orifices 23 which are all in communication with the room 21, wherein the fertilizer is put into the room 21 via the opening 22, and the at least two first orifices 23 are used to release the fertilizer accommodated in the room 21. Since too much fertilizer is harmful to the plant, two preferred embodiments of the present invention which are served to control the amount of the fertilizer to be released are described in the following.

In a first embodiment, as shown in FIG. 2, the room 21 of the second part 2 has a separation member 24 located therein such that the room 21 is separated into a top room 211 and a bottom room 212. In more detail, the top room 211 does not communicate with the bottom room 212, the fertilizer is accommodated in the top room 211, and the at least two first orifices 23 are located at the top room 211. When the water enters into the top room 211 via the at least two first orifices 23, a portion of the fertilizer is dissolved in the water and thus flows out together with the water via the at least two first orifices 23. Likewise, when the water level is equal to or lower than the height of the bottom room 212, i.e., no water in the top room 211, the fertilizer in the top room 211 is no longer dissolved. Hence, the amount of the fertilizer to be released can be controlled. Preferably, to increase the amount of water storage, at least two second orifices 25 are provided at the bottom room 212, such that the water can flow into and be stored in the bottom room 212 via the at least two second orifices 25.

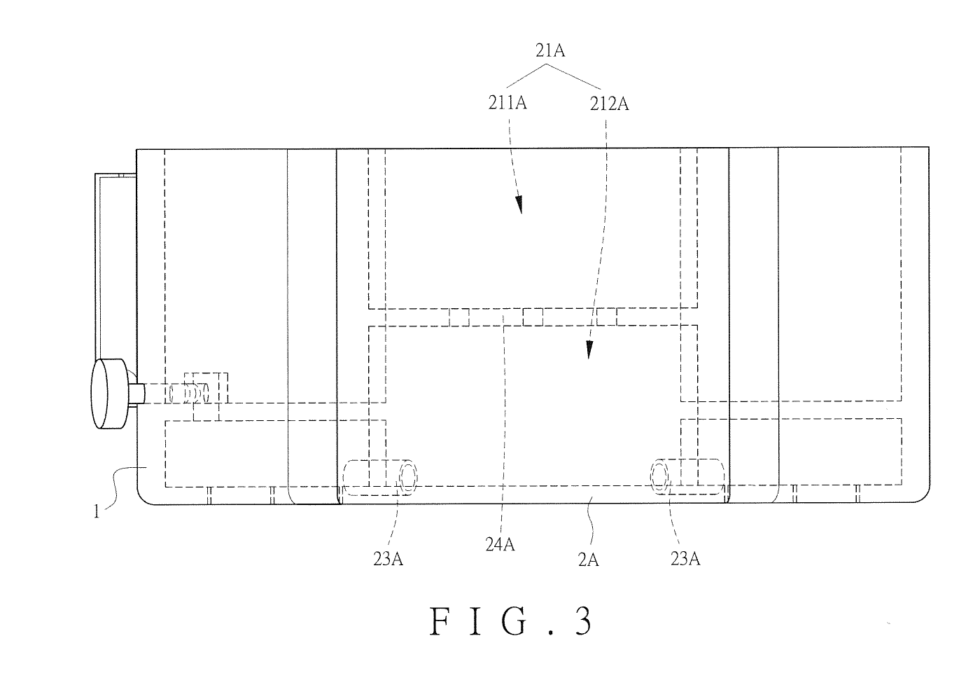

In a second embodiment, as shown in FIG. 3, the room 21A of the second part 2A has a separation member 24A located therein such that the room 21A is subdivided into a top room 211A and a bottom room 212A. Specifically, the top room 211 A communicates with the bottom room 212A, the fertilizer is accommodated in the top room 211A, and the at least two first orifices 23A are located at the bottom room 212A. When the water flows into the bottom room 212A via the at least two first orifices 23A and is raised to the top room 211A, a portion of the fertilizer is dissolved in the water so as to flow out together with the water via the at least two first orifices 23A, and when the water level is lowered to the bottom room 212A, the fertilizer in the top room 211A is no longer dissolved. Therefore, the amount of the fertilizer to be released can be controlled.

The details of the first embodiment are further described herein. The pipe 3 is arranged along the first part 1 and connects between the first part 1 and the second part 2, so that the first part 1 communicates with the second part 2 via the pipe 3. This arrangement is served to supply the water and fertilizer to the soil evenly, rather than only to a small area of the soil. In more detail, the pipe 3 has a first end coupled to the outlet 14 of the first part 1. A second end of the pipe 3 is connected with the at least two first orifices 23 of the second part 2 such that the first part 1 communicates with the top room 211 of the second part 2 via the pipe 3 to form a first flow path. A third end of the pipe 3 is connected with the at least two second orifices 25 of the second part 2 such that the first part 1 communicates with the bottom room 212 of the second part 2 via the pipe 3 to form a second flow path. Otherwise, in the second embodiment, an end of the pipe 3 is connected with the at least two first orifices 23A located at the bottom room 212A of the second part 2A, and thus the first part 1 communicates with the second part 2A to form a single flow path. Preferably, the pipe 3 has a plurality of apertures 31 distributed over the wall thereof. Alternatively, the pipe 3 can be a porous pipe. Although the pipe 3 is disposed at the bottom of the first part 1 in this embodiment, it is noted that the arrangement of the pipe 3 is not limited. For example, the pipe 3 also can be arranged at the side wall of the first part 1 or any position where the water and fertilizer can be supplied to the most area of the soil. Thus, the soil can absorb the water and fertilizer in a large area. In order to control the amount of water that enters into the pipe 3, a valve 4 is coupled to the outlet 14 of the first part 1 to control the amount of water. Alternatively, a water level meter 5 is coupled to the first part 1 and communicates with the water storage space 12 to measure the water level in the water storage space 12, and thus users can learn the water level easily by observing the water level meter 5.

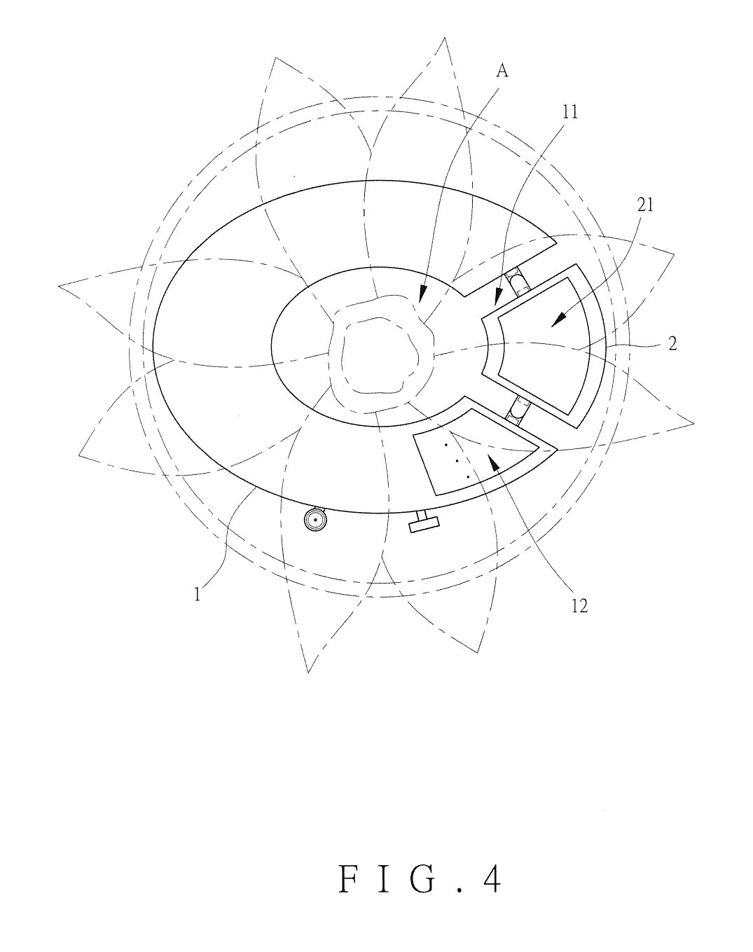

Referring to FIGS. 2 and 4, to use, the water storage space 12 of the first part 1 is filled with water, and the fertilizer is put in the room 21 of the second part 2. Thereafter, the first part 1 is placed on the soil for planting and let the plant pass through the notch 11 to be located at the central hole “A” of the first part 1. The second part 2 is then placed within the notch 11 so that the first and second orifices 23, 25 thereof are connected with the pipe 3, as described in the first embodiment of the present invention.

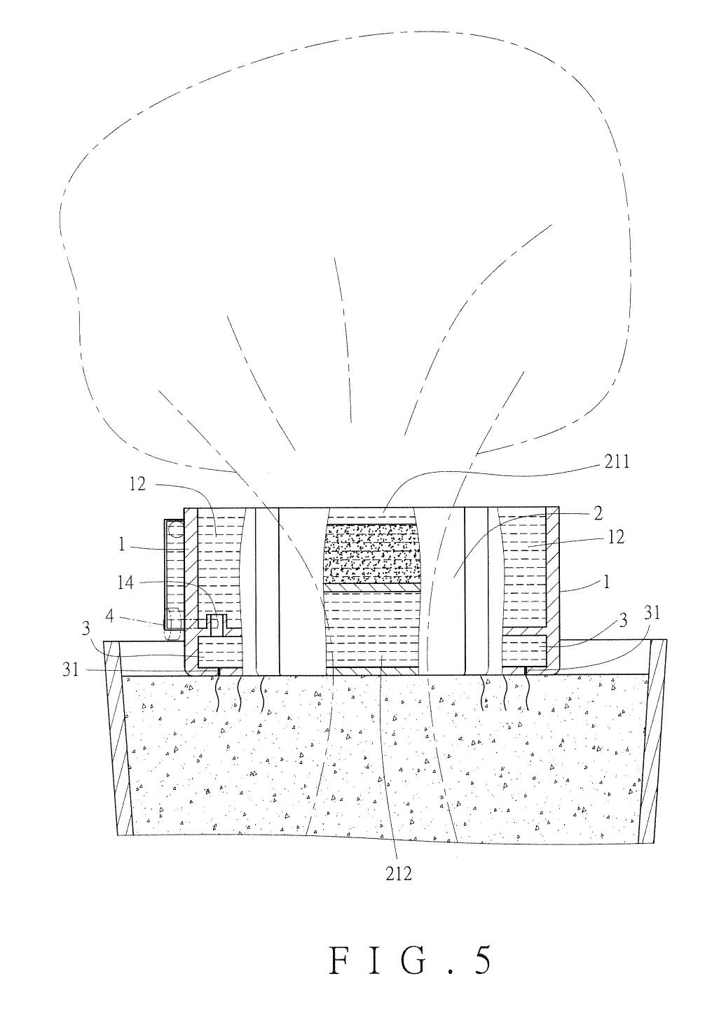

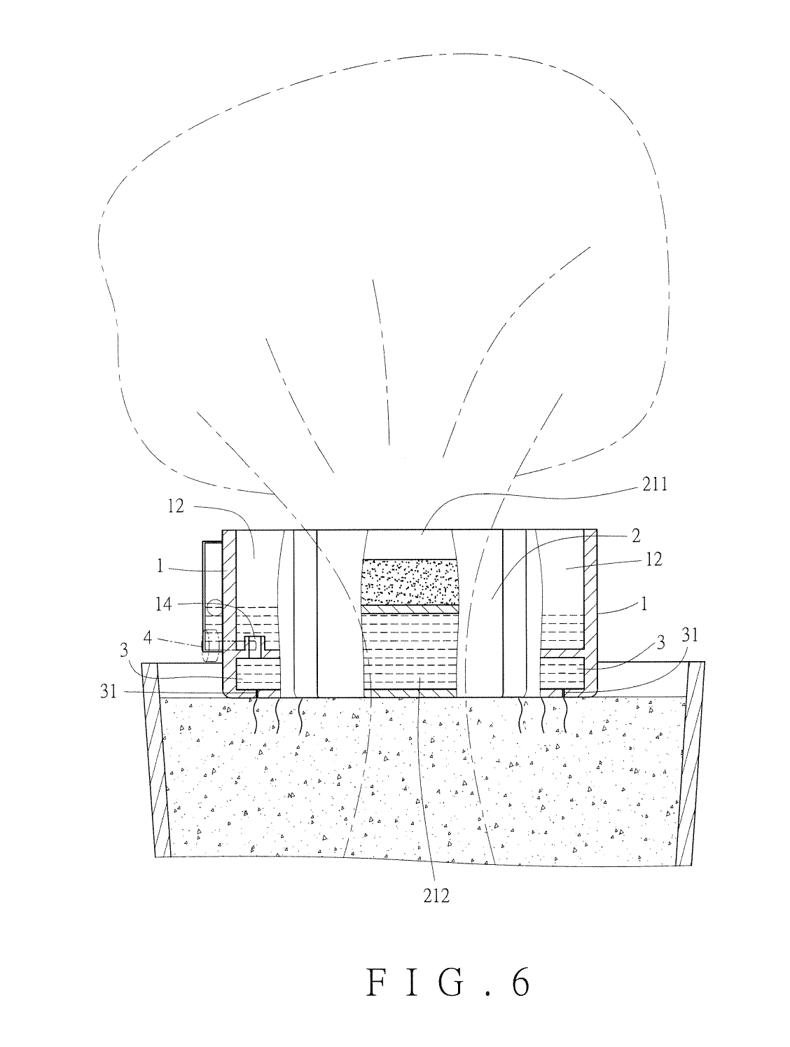

With reference to FIG. 5, when the valve 4 is opened to allow the water stored in the water storage space 12 to flow into the pipe 3 and to enter the second part 2, the water is guided into both of the top and bottom rooms 211, 212 by using the principle of differential-pressure, and meanwhile the users can fill up the water storage space 12 with water. Hence, referring to FIG. 6, the fertilizer accommodated in the top room 211 is dissolved in the water, and then the mixture of the water and the fertilizer is released through the plurality of apertures 31 of the pipe 3 to be supplied to the soil evenly. When the water level declines to a level, the fertilizer in the top room 211 is no longer dissolved, thus avoiding over-fertilization which may adversely affect the growth of the plant. Therefore, the plant placed in the central hole “A” is properly and continuously fertilized and watered.

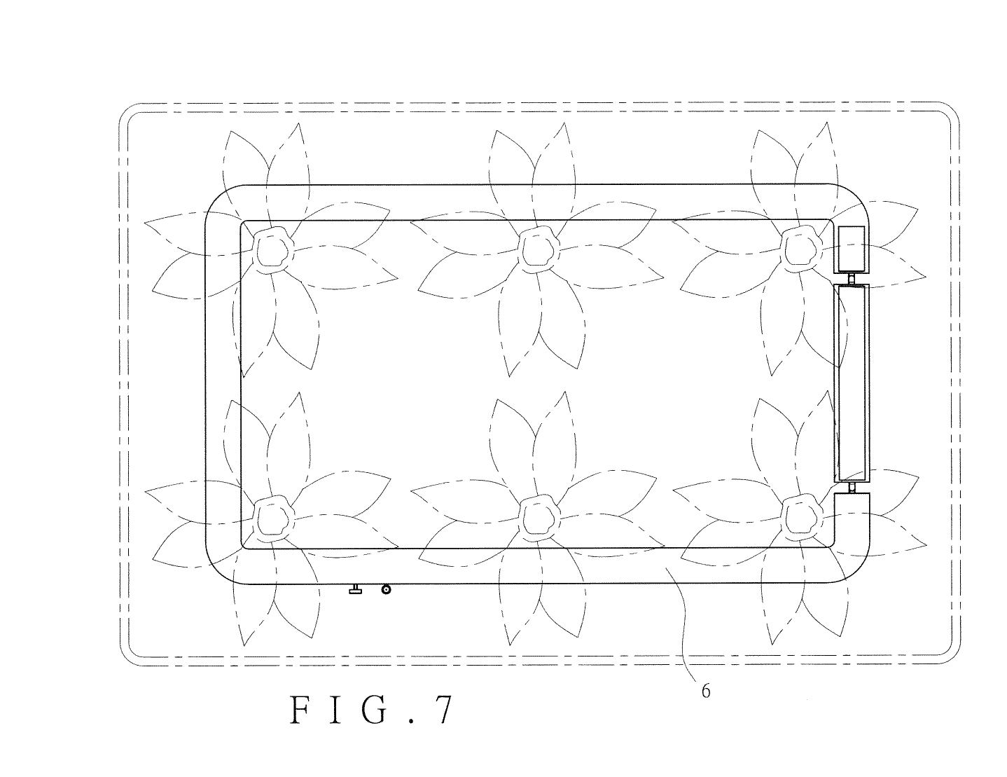

FIG. 7 shows another application of the present invention, wherein a water supply device 6 is placed in a larger planting area, such as in a garden or a farm, to water and fertilize the plants in the planting area for a longer period of time and to maintain the soil with proper humidity. The amount of fertilizer that is released is controlled to prevent the plants from over-fertilization. Besides, when in use, the water supply device of the present invention is simply placed on the planting area without extra arrangement of pipes and merely occupies small space, so it is rather suitable for a pot or a small planting area.

While we have shown and described the embodiment in accordance with the present invention, it should be clear to those skilled in the art that further embodiments may be made without departing from the scope of the present invention.

What is claimed is:

1. A water supply device adapted to be placed on or buried in soil for planting and comprising:
a first part being an annular part with a notch, the first part having a water storage space defined therein and having an inlet and an outlet, the inlet and the outlet being in communication with the water storage space;
a second part located within the notch, the second part having a room for accommodating fertilizer therein and having an opening and at least two first orifices, the opening and the at least two first orifices being in communication with the room; and
a pipe disposed along the first part, the pipe being connected with the outlet of the first part and the at least two orifices of the second part and forming a first flow path, the pipe having a plurality of apertures distributed over a wall thereof.

2. The device as claimed in claim 1, wherein the room of the second part has a separation member disposed therein such that the room is subdivided into a top room and a bottom room by the separation member, the top room is configured to accommodate the fertilizer, the bottom room communicates with the top room, and the at least two first orifices are located at the bottom room.

3. The device as claimed in claim 1, wherein the room of the second part has a separation member disposed therein such that the room is subdivided into a top room and a bottom room, the top room is configured to accommodate the fertilizer, the bottom room does not communicate with the top room, and the at least two first orifices are located at the top room.

4. The device as claimed in claim 3, wherein the bottom room has at least two second orifices, and the at least two second orifices are in connection with the pipe so as to form a second flow path.

5. The device as claimed in claim 1 further comprising a valve coupled to the outlet of the first part.

6. The device as claimed in claim 1 further comprising a water level meter coupled to the first part, the water level meter communicating with the water storage space and measuring a water level in the water storage space.

7. The device as claimed in claim 1, wherein the pipe is coupled with the first part and located below the first part.

8. A water supply device adapted to be placed at periphery of a plant and comprising:
a first part for storing water therein, a second part for accommodating fertilizer therein, and a pipe connected between the first part and the second part, wherein the pipe has a plurality of apertures distributed over a wall thereof such that the water stored in the first part passes through the plurality of apertures of the pipe to be supplied to the plant.
